(19) United States
(12) Patent Application Publication
(10) Pub. No.: US 2008/0052560 A1
(43) Pub. Date: Feb. 28, 2008

(54) Field bus communication diagnosing device and field bus communication diagnosing method

(75) Inventor: Toshiya Murai, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/894,149

(22) Filed: Aug. 20, 2007

(30) Foreign Application Priority Data
Aug. 22, 2006 (JP) 2006-224839

(51) Int. Cl. G06F 11/00

(52) U.S. Cl. 714/31; 714/E11.001

(57) ABSTRACT

A communication state storing unit stores the communication error states of the field bus communication. A connecting state updating unit updates a connecting state of the field bus communication of two systems. A diagnosing unit sequentially and periodically obtains the communication error states stored in the communication state storing unit to diagnose the communication state of the field bus communication in accordance with the obtained communication error state, and sequentially and periodically obtains the connecting states updated by the connecting state updating unit to diagnose the communication state of the field bus communication in accordance with the obtained connecting state.

This application claims priority to Japanese Patent Application No. 2006-224839, filed Aug. 22, 2006, in the Japanese Patent Office. The priority application is incorporated by reference in its entirety.

### TECHNICAL FIELD

The present disclosure relates to a field bus communication diagnosing device and a field bus communication diagnosing method for diagnosing the communication state of a field bus communication.

### RELATED ART

In a plant control system, a communication is carried out between a field device and a field controller through a field bus. As a standard of a field bus communication, for instance, a FOUNDATION filed bus communication is known.

There is a tool for diagnosing a communication state in such a field bus communication. An operator manually activates the tool so that the communication state can be diagnosed.

A data collecting system is disclosed in, for instance, Japanese Patent Unexamined Publication No. 2005-32086, in which data is collected in accordance with a cycle of performing a diagnosis and a communication load can be equalized.

However, when the communication state is diagnosed by using the tool, the operator needs to carry out a prescribed operation by manually activating the tool, for instance, several times a day. This imposes a burden on the operator.

Further, when the tool is used, only the communication state during activating the tool is diagnosed. Accordingly, the communication state cannot be monitored in a real time. Further, a diagnosis using the tool is not associated with the operation of the plant control system, and even when an abnormality is detected in the diagnosis, a system alarm of the plant control system is not informed of.

### SUMMARY

Exemplary embodiments of the present invention provide a field bus communication diagnosing device and a field bus communication diagnosing method that can properly diagnose the abnormality of a field bus communication without imposing a burden on an operator.

A field bus communication diagnosing device of one or more exemplary embodiments according to the present invention concerns a field bus communication diagnosing device for diagnosing the communication state of a field bus communication. The field bus communication diagnosing device comprises: a communication state storing unit that stores the communication error states of the field bus communication; and a diagnosing unit that sequentially obtains the communication error states stored in the communication state storing unit at a prescribed timing to diagnose the communication state of the field bus communication in accordance with the obtained communication error state, and is characterized in that the diagnosing unit compares the communication error state obtained the last time with the communication error state obtained this time to diagnose the communication state as an abnormality of communication when the communication error state is deteriorated.

According to this field bus communication diagnosing device of one or more exemplary embodiments according to the present invention, since the stored communication error states are sequentially obtained at a prescribed timing and the communication state of the field bus communication is diagnosed in accordance with the obtained communication error state, the abnormality of the field bus communication can be properly diagnosed without imposing the burden on the operator.

A field bus communication diagnosing device of one or more exemplary embodiments according to the present invention concerns a field bus communication diagnosing device for diagnosing the communication state of a duplex field bus communication. The field bus communication diagnosing device comprises: a connecting state updating unit that updates a connecting state of the field bus communication of two systems; and a diagnosing unit that sequentially obtains the connecting states updated by the connecting state updating unit at a prescribed timing to diagnose the communication state of the field bus communication in accordance with the obtained connecting state, and is characterized in that the diagnosing unit compares the connecting states of the field bus communication of the two systems with each other, and when the connecting states do not correspond to each other, the diagnosing unit diagnoses the communication state as an abnormality of communication.

According to this field bus communication diagnosing device of one or more exemplary embodiments according to the present invention, since the updated connecting states of the field bus communication of the two systems are sequentially obtained at a prescribed timing and the communication state of the field bus communication is diagnosed in accordance with the obtained connecting state, the abnormality of the field bus communication can be properly diagnosed without imposing the burden on the operator.

The diagnosing unit may periodically diagnose the communication state.

The diagnosing unit may inform an operator of an alarm showing the abnormality when the communication state is diagnosed as the abnormality of communication.

A field bus communication diagnosing method of one or more exemplary embodiments according to the present invention concerns a field bus communication diagnosing method for diagnosing the communication state of a field bus communication. The field bus communication diagnosing method comprises: a step of storing the communication error states of the field bus communication; and a step of sequentially obtaining the communication error states stored in the step of storing the communication error states at a prescribed timing to diagnose the communication state of the field bus communication in accordance with the obtained communication error state, and is characterized in that in the step of diagnosing the communication state, the communication error state obtained the last time is compared with the communication error state obtained this time to diagnose the communication state as an abnormality of communication when the communication error state is deteriorated.

According to this field bus communication diagnosing method of one or more exemplary embodiments according to the present invention, since the stored communication error states are sequentially obtained at a prescribed timing and the communication state of the field bus communication is diagnosed in accordance with the obtained communication error state the abnormality of the field bus communication can be properly diagnosed without imposing the burden on the operator.

A field bus communication diagnosing method of one or more exemplary embodiments according to the present invention concerns a field bus communication diagnosing method for diagnosing the communication state of a duplex field bus communication. The field bus communication diagnosing method comprises: a step of updating a connecting state of the field bus communication of two systems; and a step of sequentially obtaining the connecting states updated in the step of updating the connecting state at a prescribed timing to diagnose the communication state of the field bus communication in accordance with the obtained connecting state, and is characterized in that in the step of diagnosing the communication state, the connecting states of the field bus communication of the two systems are compared with each other, and when the connecting states do not correspond to each other, the communication state is diagnosed as an abnormality of communication.

According to this field bus communication diagnosing method of one or more exemplary embodiments according to the present invention, since the updated connecting states of the field bus communication of the two systems are sequentially obtained at a prescribed timing and the communication state of the field bus communication is diagnosed in accordance with the obtained connecting state, the abnormality of the field bus communication can be properly diagnosed without imposing the burden on the operator.

One or more exemplary embodiments of the present invention may include one or more the following advantages. For example, according to the field bus communication diagnosing device of one or more exemplary embodiments according to the present invention, since the stored communication error states are sequentially obtained at a prescribed timing and the communication state of the field bus communication is diagnosed in accordance with the obtained communication error state, the abnormality of the field bus communication can be properly diagnosed without imposing the burden on the operator.

According to the field bus communication diagnosing device of one or more exemplary embodiments according to the present invention, since the updated connecting states of the field bus communication of the two systems are sequentially obtained at a prescribed timing and the communication state of the field bus communication is diagnosed in accordance with the obtained connecting state, the abnormality of the field bus communication can be properly diagnosed without imposing the burden on the operator.

According to the field bus communication diagnosing method of one or more exemplary embodiments according to the present invention, since the stored communication error states are sequentially obtained at a prescribed timing and the communication state of the field bus communication is diagnosed in accordance with the obtained communication error state, the abnormality of the field bus communication can be properly diagnosed without imposing the burden on the operator.

According to the field bus communication diagnosing method of the present invention, since the updated connecting states of the field bus communication of the two systems are sequentially obtained at a prescribed timing and the communication state of the field bus communication is diagnosed in accordance with the obtained connecting state, the abnormality of the field bus communication can be properly diagnosed without imposing the burden on the operator.

Other features and advantages may be apparent from the following detailed description, the accompanying drawings and the claims.

### BRIEF DESCRIPTION OF THE DRAWINGS

FIG. 1 is a block diagram showing the structure of a distributed plant control system to which a field bus communication diagnosing device of an exemplary embodiment is applied.

FIGS. 2-4 are flowcharts showing the operation of a field controller as the field bus communication diagnosing device of the exemplary embodiment.

### DETAILED DESCRIPTION

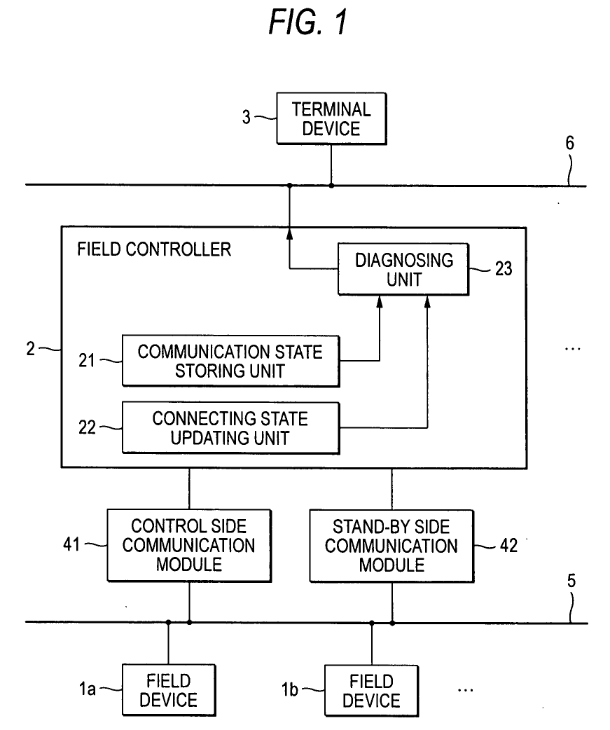

Now, an exemplary embodiment of a field bus communication diagnosing device according to the present invention will be described below by referring to FIGS. 1 to 4.

FIG. 1 is a block diagram showing the structure of a distributed plant control system to which the field bus communication diagnosing device of an exemplary embodiment is applied.

As shown in FIG. 1, the plant control system includes field controllers 2, 2, . . . distributed and arranged in the plant to control field devices 1a, 1b, . . . , and a terminal device 3 for monitoring the field devices 1a, 1b, . . . , through the field terminal device 3 are connected together through a control bus 6.

As shown in FIG. 1, a communication between the field devices 1a, 1b, . . . and the field controller 2 is duplexed by using a control side communication module 41 and a stand-by side communication module 42. The control side communication module 41 and the stand-by side communication module 42 are connected to the field devices 1a, 1b, . . . through a field bus 5 to carry out a field bus communication between them. As the field bus 5, for instance, a FOUNDATION field bus is used.

The control side communication module 41 and the stand-by side communication module 42 carry out the same communication in parallel between the field controller 2 and the field devices 1a, 1b, . . . . Further, both the modules basically carry out the same information processes in parallel. However, at an ordinary time, output data (process data from the field devices 1a, 1b, . . . ) from the control side communication module 41 is used in the field controller 2. Further, at an abnormal time of the control side, output data from the stand-by side communication module 42 is used in the field controller 2 in place of the output data from the control side communication module 41. In such a way, the field bus communications of two systems are carried out in parallel so that the data used in the field controller 2 is switched.

As shown in FIG. 1, the field controller 2 includes a communication state storing unit 21 that stores the communication error states of the field bus communication; a connecting state updating unit 22 that updates a connecting state of the field bus communication of the two systems, and a diagnosing unit 23 that sequentially and periodically obtains the communication error states stored in the communication state storing unit 21 to diagnose the communication state of the field bus communication in accordance with the obtained communication error state, and sequentially and periodically obtains the connecting states updated by the connecting state updating unit 22 to diagnose the communication state of the field bus communication in accordance with the obtained connecting state.

The diagnosing unit 23 compares the communication error state obtained the last time with the communication error state obtained this time to diagnose the communication state as an abnormality of communication when the communication error state is deteriorated. Further, the diagnosing unit 23 compares the connecting states of the field bus communication of the two systems with each other, and when the connecting states do not correspond to each other, the diagnosing unit 23 diagnoses the communication state as an abnormality of communication. The functions of the communication state storing unit 21, the connecting state updating unit 22 and the diagnosing unit 23 will be further described below.

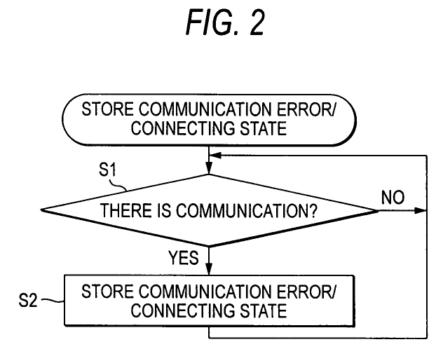

FIG. 2 is a flowchart showing the operation of the field controller 2 as the field bus communication diagnosing device of the exemplary embodiment.

Steps S1 to S2 of FIG. 2 show operating procedures of the communication state storing unit 21 and the connecting state updating unit 22 of the field controller 2.

In the step S1 of FIG. 2, whether or not the field bus communication is carried out between the communication module 41 or the communication module 42 and the field devices 1a, 1b, . . . is decided to wait for the affirmation of a decision and advance to the step S2.

In the step S2, objects of the communication (the communication module 41 or the communication module 42 and the field devices 1a, 1b, . . . ) and the presence or absence of a communication error are recorded about the filed bus communication carried out between the communication module 41 or the communication module 42 and the field devices 1a, 1b, . . . by the communication state storing unit 21.

Further, in the step S2, the connecting state (connection/non-connection) between the communication module 41 and the field devices 1a, 1b, . . . and the connecting state (connection/non-connection) between the communication module 42 and the field devices 1a, 2b, . . . are detected and updated by the connecting state updating unit 22 in accordance with the communication between the communication module 41 or the communication module 42 and the field devices 1a, 1b, . . . .

As described above, since the communication module 41 and the communication module 42 are requested to carry out the same communications in parallel, when the system is normal, the connecting states of the communication module 41 and the communication module 42 are equivalent. That is, the connecting states (connection/non-connection) of the communication module 41 and the communication module 42 to the individual field devices 1a, 1b, . . . should correspond to each other.

After the process of the step S2 is finished, the procedure returns to the step S1.

As described above, the processes of the step S1 to the step S2 are repeated so that the communication error states are stored one after another by the communication state storing unit 21 and the connecting states are successively updated by the connecting state updating unit 22.

Steps S11 to S14 show an operating procedure for diagnosing an abnormality of the communication error state by the diagnosing unit 23. This operating procedure is periodically carried out.

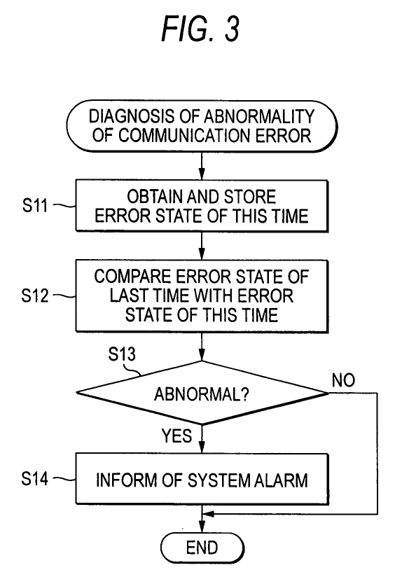

In the step S11 of FIG. 3, the diagnosing unit 23 accesses the communication state storing unit 21 to obtain the stored communication error states and temporarily store the communication error states. In the communication state storing unit 21, the communication error state of one cycle is stored from an access of the last time. In the step S11, the communication error state of the one cycle is obtained.

Then, in the step S12, the communication error state of the last time obtained by the access of the last time is compared with a communication error state of this time obtained by an access of this time. Here, the communication error state of the last time is temporarily stored during the access of the last time (step S11).

Then, in the step S13, it is decided whether or not the communication error state of this time is deteriorated more than that of the last time.

Here, for instance, the increase of the number of times of communication errors included in the communication error state is detected. For instance, when the value of this time of the number of times of the communication errors increases more by a prescribed value or more than the value of the last time, a decision of the step S13 is affirmed.

When the decision of the step S13 is affirmed, the procedure advances to the step S14. When the decision is negated, the procedure is finished.

In the step S14, the diagnosing unit 23 informs the terminal device 3 of a system alarm showing the abnormality of the communication error state through the control bus 6. When the terminal device 3 receives the system alarm, the system alarm showing the abnormality of the communication error state is displayed on the screen of the terminal device 3.

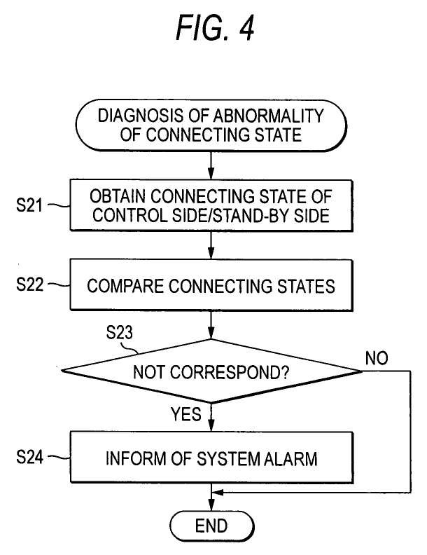

Steps S21 to S24 of FIG. 4 show an operating procedure for diagnosing the abnormality of the connecting state by the diagnosing unit 23. This operating procedure is carried out periodically.

In the step S21 of FIG. 2, the diagnosing unit 23 accesses the connecting state updating unit 22 to obtain the latest connecting state. Here, the connecting states of the communication module 41 and the communication module 42 are obtained.

Then, in the step S22, the connecting state of the communication module 41 is compared with the connecting state of the communication module 42. After that, in the step S23, it is decided whether the connecting state of the communication module 41 does not correspond to the connecting state of the communication module 42 in accordance with the compared result in the step S22. When the decision of the step S23 is affirmed, the procedure advances to the step S24. When the decision is negated, the procedure is finished.

As described above, when the system is normal, since the connecting states of the communication module 41 and the communication module 42 are equivalent, the decision of the step S23 should be negated. When the abnormality arises in the communication module 41 or the communication module 42, desired connecting states are not obtained and the connecting states do not correspond to each other. Therefore, the decision of the step S23 is affirmed.

When the decision of the step S23 is affirmed, in the step S24, the system alarm showing that the connecting states do not correspond to each other is informed of to finish the procedure. When the terminal device 3 receives the system alarm, the system alarm showing that the connecting states do not correspond to each other is displayed on the screen of the terminal device 3.

In the above-mentioned field bus communication diagnosing device of the exemplary embodiment, both of the communication states stored in the communication state storing unit 21 and the connecting states updated by the connecting state updating unit 22 are periodically obtained to diagnose the abnormality; however, the present invention is not limited to this embodiment. The diagnosis of the abnormality maybe performed based on the communication state of the communication or the connecting state.

As described above, according to the field bus communication diagnosing device of the exemplary embodiment, the communication state of the communication or the connecting state using the field bus 5 is periodically automatically monitored, and when the abnormality is detected, the system alarm is informed of. Accordingly, the operation of an operator for diagnosing the communication state is not required to reduce the burden of the operator. Further, since the abnormality of the filed bus communication can be detected substantially in a real time and informed, the generation of the abnormality can be rapidly met. Further, the system alarm is displayed on the terminal device 3, so that the distributed plant control system including the abnormality of the field bus communication can be integrally monitored.

Further, in the field bus communication diagnosing device of the exemplary embodiment, when the field bus communication is diagnosed, it is diagnosed in accordance with the communication state of a communication carried out during the operation of the plant without transmitting and receiving data for diagnosis. Therefore, the communication state of the field bus communication can be diagnosed in a real time without giving an adverse effect to the operation of the plant.

In the above-described embodiment, since the communication states stored in the communication state storing unit 21 or the connecting states updated by the connecting state updating unit 22 are periodically obtained to diagnose the abnormality, a quantity of data to be stored in the communication state storing unit 21 or the connecting state updating unit 22 can be suppressed. Therefore, the burden of the field controller 2 can be reduced relative to a storage capacity.

On the other hand, to effectively utilize the communication state stored in the communication state storing unit 21 or the connecting state updated by the connecting state updating part 22, the communication state stored in the communication state storing unit 21 or the updated connecting state may be transferred to the terminal device 3 at a proper time and these data may be stored in the terminal device 3. Further, the diagnosed result by the diagnosing unit 23 may be stored in the terminal device 3.

Thus, the history of the communication states in the past or the history of the diagnosed results can be displayed in a list on the terminal device 3, or graphs can be currently displayed using the histories by various kinds of information processes.

An applied range of the present invention is not limited to the above-described embodiment. The present invention can be widely applied to the field bus communication diagnosing device and the field bus communication diagnosing method for diagnosing the communication state of the field bus communication.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A field bus communication diagnosing device for diagnosing the communication state of a field bus communication, said device comprising:
a communication state storing unit that stores the communication error state of the field bus communication; and
a diagnosing unit that sequentially obtains the communication error state stored in the communication state storing unit at a prescribed timing to diagnose the communication state of the field bus communication in accordance with the obtained communication error state,
wherein the diagnosing unit compares the communication error state obtained the last time with the communication error state obtained this time and diagnoses the communication state as an abnormality of communication when the communication error state is deteriorated.

2. A field bus communication diagnosing device for diagnosing the communication state of a duplex field bus communication, said device comprising:
a connecting state updating unit that updates a connecting state of the field bus communication of two systems; and
a diagnosing unit that sequentially obtains the connecting state updated by the connecting state updating unit at a prescribed timing to diagnose the communication state of the field bus communication in accordance with the obtained connecting state,
wherein the diagnosing unit compares the connecting states of the field bus communication of the two systems with each other, and when the connecting states do not correspond to each other, the diagnosing unit diagnoses the communication state as an abnormality of communication.

3. A field bus communication diagnosing device according to claim 1, wherein the diagnosing unit periodically diagnoses the communication state.

4. A field bus communication diagnosing device according to claim 2, wherein the diagnosing unit periodically diagnoses the communication state.

5. A field bus communication diagnosing device according to claim 1, wherein the diagnosing unit informs an operator of an alarm showing the abnormality when the communication state is diagnosed as the abnormality of communication.

6. A field bus communication diagnosing device according to claim 2, wherein the diagnosing unit informs an operator of an alarm showing the abnormality when the communication state is diagnosed as the abnormality of communication.

7. A field bus communication diagnosing device according to claim 2, further comprising:
a communication state storing unit that stores the communication error state of the field bus communication
wherein diagnosing unit sequentially obtains the communication error state stored in the communication state storing unit at a prescribed timing to diagnose the communication state of the field bus communication in accordance with the obtained communication error state,
wherein the diagnosing unit compares the communication error state obtained the last time with the communication error state obtained this time and diagnoses the communication state as an abnormality of communication when the communication error state is deteriorated.

8. A field bus communication diagnosing method for diagnosing the communication state of a field bus communication, said method comprising:
a step of storing the communication error state of the field bus communication; and
a step of sequentially obtaining the communication error state stored in the step of storing the communication error state at a prescribed timing to diagnose the communication state of the field bus communication in accordance with the obtained communication error state,
wherein in the step of diagnosing the communication state, the communication error state obtained the last time is compared with the communication error state obtained this time and the communication state is diagnosed as an abnormality of communication when the communication error state is deteriorated.

9. A field bus communication diagnosing method for diagnosing the communication state of a duplex field bus communication, said method comprising:
a step of updating a connecting state of the field bus communication of two systems; and
a step of sequentially obtaining the connecting state updated in the step of updating the connecting state at a prescribed timing to diagnose the communication state of the field bus communication in accordance with the obtained connecting state,
wherein in the step of diagnosing the communication state, the connecting states of the field bus communication of the two systems are compared with each other, and when the connecting states do not correspond to each other, the communication state is diagnosed as an abnormality of communication.
